(19) United States
(12) Patent Application Publication
(10) Pub. No.: US 2017/0001389 A1
(43) Pub. Date: Jan. 5, 2017

(54) METHOD AND DEVICE FOR REPAIRING COMPONENTS

(71) Applicant: AIRBUS DEFENCE AND SPACE GMBH, Taufkirchen (DE)

(72) Inventors: Franz ENGEL, Munich (DE); Tilman ORTH, Munich (DE); Christian WEIMER, Munich (DE)

(21) Appl. No.: 15/196,855

(22) Filed: Jun. 29, 2016

(30) Foreign Application Priority Data
Jun. 30, 2015 (DE) 10 2015 008 312.0

(51) Int. Cl. B29C 73/34; B29C 35/00; B29C 35/02; B29C 73/02; B29C 35/08

(52) U.S. Cl. CPC B29C 73/34; B29C 73/02; B29C 35/0805; B29C 35/0266; B29C 35/002; B29K 2105/06

(57) ABSTRACT

A method for repairing a component which contains fiber-reinforced plastics material. For curing a deformable material introduced into and/or applied to a repair point of the component, the material is heated by irradiation with light from a light-emitting device. The disclosure herein further relates to a light-emitting device for heating a material that is deformable at least in part, in a method according to the disclosure herein, and to a repair device which comprises a light-emitting device.

### CROSS-REFERENCE TO RELATED APPLICATION

This application claims priority to DE 10 2015 008 312.0 filed Jun. 30, 2015, the entire disclosure of which is incorporated by reference herein.

### TECHNICAL FIELD

The disclosure herein relates to a method and a device for repairing components which contain fiber-reinforced plastics material.

### BACKGROUND

Fiber-reinforced components are used in many fields, in particular in such fields in which both a high material strength and a relatively low weight are advantageous. Components made of fiber composite materials are thus used for example in aviation and aerospace technology and in addition in the production of sports equipment or vehicles and in installations and buildings.

If such a component is damaged, a repair method is known in which an exposed damaged point is taped off by a cured patch made of fiber-reinforced material. Alternatively, a repair point can be spliced and the resulting joint can be covered with semi-cured patches made of fiber composite material or can be repaired using dry fibers and (fluid or viscous) matrix material. The repaired point is then heated in each case, in order to cure the repair material.

Radiant heaters or heating mats are conventionally used for the heating. However, the radiant heaters or heating mats generally do not have good energy efficiency. In addition, the heaters are bulky and generally require a large construction. Lastly, the introduction of heat into the material by these heaters can hardly be dynamically controlled, or can be dynamically controlled only in a very complex manner.

### SUMMARY

It is one idea of the present disclosure is to provide an improved technique for repairing components containing fiber-reinforced plastics material.

This is achieved by a method, light-emitting device, and a repair device as disclosed herein.

A method according to the disclosure herein facilitates a repair of a component which contains fiber-reinforced plastics material. The method comprises introducing and/or applying at least one material which can be deformed at least in part into or to a repair point of the component, and comprises heating the deformable material. The heating comprises irradiating the deformable material with light from a light-emitting device.

The fiber-reinforced plastics material can contain carbon fibers, glass fibers, polyethylene fibers and/or aramid fibers for example.

A method according to the disclosure herein is suitable for one-off repairs, but also for repeated repairs. For example, a repair point can have a new defect after the deformable material has been heated and the method can include a new repair of the component at the repair point.

A light-emitting device according to the disclosure herein is designed to be used or is suitable for being used in an embodiment of a method according to the disclosure herein for heating a material that is deformable at least in part.

A repair device according to the disclosure herein facilitates a repair of a component which contains fiber-reinforced plastics material, and comprises a light-emitting device according to the disclosure herein.

A method according to the disclosure herein, a light-emitting device according to the disclosure herein and a repair device according to the disclosure herein permit heating and thus curing of the deformable material, which heating and curing can be dynamically controlled in an advantageous and simple manner and has a high energy efficiency compared with conventional heating. In addition, a repair point can be treated in a targeted manner by locally varying introductions of heat.

The material which can be deformed at least in part can comprise for example a cured patch made of fiber-reinforced material having a non-cured adhesive, and/or a semi-cured parch made of fiber composite material (which can contain reactive groups, i.e. molecules which can in addition bond with an adhesive or a matrix material). Alternatively or additionally, the material that is deformable at least in part can comprise a fluid or viscous plastics material and/or dry fibers which are infiltrated with a deformable (preferably fluid or viscous) matrix material. Heating the deformable material preferably causes or accelerates the curing thereof.

A method according to the disclosure herein can comprise grinding, milling and/or splicing damage at a repair point of the component before the material that is deformable at least in part is introduced into or applied to the repair point.

The light-emitting device can comprise for example at least one radiator as a light source. According to a preferred embodiment of a method according to the disclosure herein, the light-emitting device comprises at least one inorganic light-emitting diode and/or at least one organic light-emitting diode (which can be controlled via a passive or active matrix for example); a particularly good energy efficiency can thus be achieved.

When irradiating the deformable material, the light-emitting device is preferably positioned at a spacing of a maximum of 10 cm or a maximum of 5 cm, preferably a maximum or 2 cm, more preferably at a spacing of 0 cm-1 cm, from the material. In this way, the introduction of heat can be particularly well monitored and/or controlled in a precisely positioned manner, because a scattering of the light is minimized.

According to an advantageous variant of the present disclosure, the light-emitting device is planar (for example circular or polygonal, for example rectangular or even square). In particular, the device can comprise one or more light source(s) which is/are spread over a surface of at least 1 cm², preferably of at least 900 cm², more preferably at least 4000 cm² for example. When there is a plurality of light sources, these can form, for example, a grid extending over such a surface. The device can comprise at least one planar organic light-emitting diode and/or a mat, a film, a membrane, a double membrane and/or a braid made of fibers, wires and/or cord, which can have a plurality of light sources (e.g. inorganic and/or organic light-emitting diodes). An embodiment which comprises a planar light-emitting device having a flexible surface structure (which can include the mentioned mat, film, membrane, double membrane or the braid, for example) is particularly preferred. The surface structure can in particular be designed to conform at least in part to a component, if the light-emitting device is pressed onto the component or positioned on the component. For example, the light-emitting device can conform in this way to a curve of the component.

A planar light-emitting device of this kind can be attached particularly well to a planar repair point of the component and is then particularly suitable for irradiating (and thus heating) the deformable material at close range, for example at one of the spacings mentioned above. The plurality of light sources mentioned can comprise in particular inorganic and/or organic light-emitting diodes having different characteristics, for example different sizes and/or power densities and/or wavelengths of the emitted light, which makes possible a particularly versatile range of uses of the light-emitting device. In particular, the plurality can comprise a first light source which is designed to radiate light of a first wavelength (or in a first wavelength range) and/or of a first power (or in a first power range), and a second light source which is designed to radiate light of a second wavelength which is different from the first wavelength and/or of a second power which is different from the first power (or in a second wavelength range and/or power range which is different from the respective first ranges). In this case, the first wavelength and/or power (and/or the first wavelength range and/or power range) can be suitable for curing a first deformable material, and the second wavelength (and/or the second wavelength range and/or power range) can be suitable for curing a second deformable material which is different from the first, and/or the wavelength ranges and/or power ranges can be suitable owing to their suitability for curing deformable material of different thicknesses. Moreover, the different wavelengths can penetrate into the matrix to different depths and in this way make more homogenous curing possible.

Preferably the light sources of a plurality of a planar light-emitting device can be controlled independently of one another at least in part. In particular, a first heat output (and/or wavelength) can preferably be variably set for a first light source of the plurality, and a second heat output (and/or wavelength) that is different from the first can be variably set for a second light source; such a setting can be possible for example by one or more control circuits and/or by setting (or adjusting) the operating amperage that is present in each case for the respective light sources. A control circuit of this kind can comprise for example one or more internal (i.e. integrated in the light-emitting device) and/or external (i.e. arranged outside the light-emitting device) controller(s), which can be designed to control a voltage supply and/or current supply of particular light sources (single individual light sources or light sources combined in groups of a plurality of light sources). The controller(s) can each have for example at least one variable resistor and/or be designed to set the voltage supply or current supply of at least one associated light source (preferably cybernetically), for example depending on one or more parameters (e.g. of a temperature and/or an applied voltage). The parameter(s) can be detected for example by one or more internal and/or external sensors and can be used for the control, and/or the parameter(s) can directly influence or set a correspondingly sensitive resistor (e.g. a thermistor).

The controllability of the different light sources makes it possible, for example, to irradiate planar repair points with light from the light-emitting device and in the process for example to take into account different deformable materials which can be used in each case, and/or different material thicknesses of the introduced or applied material that is deformable at least in part, which different thicknesses can result from different depths of damage to be repaired.

A preferred variant of a method according to the disclosure herein comprises positioning the light-emitting device. In the process, the light-emitting device can be placed on and/or adhered to the material that is deformable at least in part, fixed thereto by suction cups and/or magnets, and/or suctioned from the material by the creation of a vacuum, and/or be adhered, by earlier electrostatic charging, to the material that is deformable at least in part.

Alternatively or additionally, van der Waals forces can be generated in order to fix the light-emitting device in place. For this purpose, the light-emitting device preferably has a flat surface which is designed to form a loose molecular bond with a surface of the component at the repair point.

A light-emitting device according to the disclosure herein can thus comprise at least one fixing element (such as at least one magnet and/or suction cup and/or at least one adhesive film and/or adhesive layer for fixing the light-emitting device in place.

A repair device according to the disclosure herein can comprise a vacuum unit which is designed to suction the light-emitting device onto a component to be repaired. Alternatively or additionally, a repair device according to the disclosure herein can be integrated in a manufacturing setup for a fiber-composite component.

When irradiating the deformable material, the light-emitting device can be connected to a stationary energy source, for example to a power grid, or to a mobile (preferably portable) power supply unit comprising at least one accumulator, at least one battery, at least one solar cell and/or at least one capacitor. According to an advantageous embodiment, a power supply unit of this kind is integrated or incorporated in the light-emitting device. In particular, a light-emitting device can be part of a repair device as a physically independent unit that is operable when detached and/or a mobile unit, for example a portable hand-held device (which preferably has a mass of a maximum of 10 kg, preferably of a maximum of 5 kg). An embodiment of this kind permits a simple and diverse application, for example in order to carry out unexpected emergency repairs to components.

An advantageous embodiment of a method according to the disclosure herein comprises measuring at least one temperature at the repair point and/or at the light-emitting device; a light-emitting device can have one or more corresponding measuring device(s) for measuring the temperature (such as temperature probes and/or thermistors). When a measurement is taken at the light-emitting device, heating which results from a reflection of light from the component can be detected, for example, and allows conclusions to be made about a component temperature. The measurement and/or the measuring device(s) make it possible to control the heating process and therefore the repair process.

According to a preferred embodiment of the present disclosure, the light-emitting device is controlled automatically at least in part, on the basis of a measured temperature; for this purpose, the measuring device(s) of the light-emitting device can be coupled to a calculation and control unit; a repair device according to the disclosure herein can comprise a unit of this kind.

In this way, the heating can be automatically optimized and/or a repair process can be automatically protected from overheating.

A temperature measured during a repair process can be stored in a storage device, preferably in combination with one or more associated control parameters (e.g. amperage and/or voltage applied) of the light-emitting device, which parameters are or have been set at the time of the measurement; a repair device according to the disclosure herein can comprise a storage device set up in this way. In this way, at least one empirical value can be recorded. For a repeated repair, a suitable temperature can be specifically set based on the empirical value by setting the associated control parameter(s).

A preferred embodiment of the disclosure herein will be described in further detail in the following, with reference to a drawing. Of course, individual elements and components can also be combined in manners different from those shown.

### BRIEF DESCRIPTION OF THE DRAWINGS

In the drawing:

FIG. 1 shows a repair device according to an embodiment of the present disclosure when in use.

### DETAILED DESCRIPTION

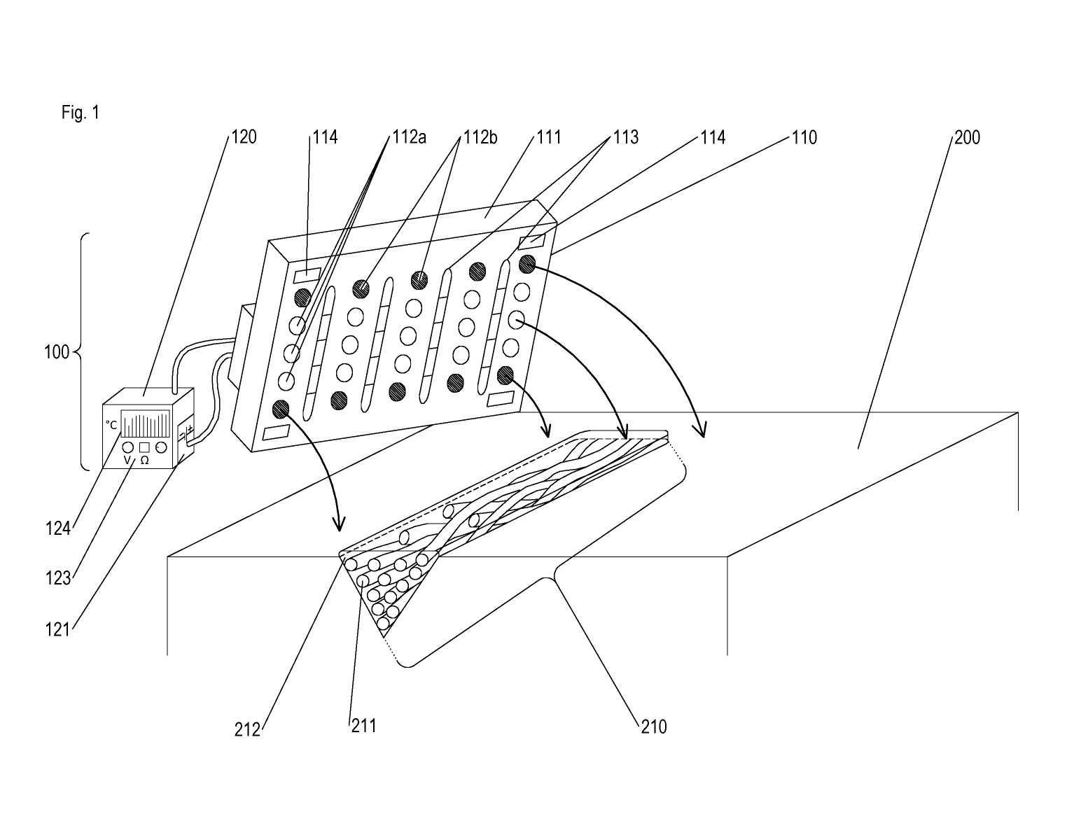

By way of example, FIG. 1 shows a repair device 100 for repairing a component 200 according to an embodiment of the present disclosure. The component 200 comprises a milled-out repair point 210 which is infiltrated with fibers 211 and a non-cured, i.e. deformable, plastics material 212.

The repair device 100 comprises a light-emitting device 110 which is positioned on the repair point 210. The light-emitting device 110 comprises a mat 111 having a rectangular base and having a plurality of light sources 112a, 112b, of which only some are provided with reference signs in the drawing for reasons of clarity. In the example shown, the light sources, which can be inorganic light-emitting diodes for example, are arranged on the mat in a grid which extents substantially across the entire base of the mat.

The mat comprises, in addition, adhesive surfaces 114 for releasably fixing the mat on the component 200, and planar temperature sensors 113 each comprising a plurality of measuring surfaces. The temperature sensors can for example be designed to detect the heat reflected by the component 200, in particular by the repair point 210, at regular time intervals and/or in response to user input.

The light-emitting device 110 is connected to a single power supply unit 121 which can comprise for example at least one battery, at least one accumulator and/or at least one capacitor.

In the embodiment shown, the power supply unit 121 is integrated in a housing of a control device 120 comprising an operating unit 122 to which the light-emitting device is also connected. As a whole, the repair device 100 is thus an independently operable unit, preferably a portable hand-held device.

Values detected by the temperature sensors 113 can be transmitted to the control device 120. In the embodiment shown, the control device comprises a display 123 on which the measured temperatures can be displayed.

When the light-emitting device 110 is suitably positioned (as indicated by the arrows), in the example shown in the drawing some of the light sources (specifically the light sources 112a arranged in the three middle rows) are arranged on the repair point 210, whereas the light sources 112b in the outer rows are arranged beside the repair point 210. The latter light sources are therefore preferably not switched on, which is shown in the drawing by shading, whereas the middle light sources 112a are illuminated, and irradiate and thereby heat the repair point, in particular the deformable plastics material 212 therein, which leads to intentional curing of the plastics material 212.

Light sources 112a, 112b to be switched on or off can preferably be selected via the operating unit 122 of the control device 120; in addition, the operating unit 122 can allow at least one control parameter of the individual light sources to be individually set in a manual or automated manner (e.g. on the basis of the temperatures measured). In particular, a power of the light sources, for example, can be controlled on the basis of a local intensity of the defect to be repaired. In the embodiment shown in the drawing, for example, a higher power is preferably set for the light sources 112a which are arranged along the middle transverse axis and which are positioned over the deepest point of the defect, than for the remaining light sources 112a.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

What is claimed is:

1. A method for repairing a component which contains fiber-reinforced plastics material, the method comprising:
introducing and/or applying material that is deformable at least one in part into and/or to a repair point of the component; and
heating the deformable material, wherein the heating comprises irradiating the deformable material with light from a light-emitting device.

2. The method according to claim 1, wherein the light-emitting device comprises at least one inorganic light-emitting diode and/or at least one organic light-emitting diode and/or at least one radiator as a light source.

3. The method according to claim 1, wherein the light-emitting device comprises at least one planar organic light-emitting diode and/or at least one mat, film, membrane, double membrane and/or at least one braid made of fibers, wires and/or cords, which can have a plurality of light sources.

4. The method according to claim 1, comprising positioning the light-emitting device, wherein, during positioning, the light-emitting device is placed on and/or adhered to the material that is deformable at least in part, fixed thereto by suction cups and/or magnets, and/or suctioned off the material by the creation of a vacuum and/or by electrostatic charging.

5. The method according to claim 1, wherein the light-emitting device is arranged at a spacing of a maximum of 15 cm or a maximum of 5 cm, preferably a maximum or 2 cm, more preferably at a spacing of 0 cm-1 cm, from the material that is deformable at least in part, and/or is integrated in a manufacturing setup for a fiber-composite component.

6. The method according to claim 1, wherein, when irradiating the deformable material, the light-emitting device is connected to a stationary energy source or to a mobile power supply unit, and/or wherein the light-emitting device comprises at least one fitted solar cell, at least one fitted accumulator, at least one inserted battery and/or at least one fitted capacitor.

7. The method according claim 1, comprising controlling the light-emitting device by at least one external and/or internal controller.

8. The method according to claim 1, comprising measuring a temperature at the repair point and/or at the light-emitting device.

9. The method according to claim 8, comprising storing at least one measured temperature together with at least one associated control parameter of the light-emitting device.

10. A light-emitting device for use in a method for repairing a component which contains fiber-reinforced plastics material, the method comprising:
introducing and/or applying material that is deformable at least one in part into and/or to a repair point of the component; and
heating the deformable material,
wherein the heating comprises irradiating the deformable material with light from a light-emitting device.

11. The light-emitting device according to claim 10, comprising at least one fixing element for fixing the light-emitting device to a repair point of a component, and/or which has a device for measuring temperature at the repair point and/or at the light-emitting device.

12. The light-emitting device according to claim 10, comprising as an energy source at least one fitted solar cell, at least one fitted accumulator, at least one inserted battery and/or at least one fitted capacitor.

13. A repair device for repairing a component which contains fiber-reinforced plastics material, the repair device comprising a light-emitting device according to claim 10.

14. The repair device according to claim 13, which is integrated in a manufacturing setup for a fiber-composite component and/or which is a portable hand-held device.
